(19) United States
(12) Patent Application Publication
(10) Pub. No.: US 2011/0143739 A1
(43) Pub. Date: Jun. 16, 2011

(54) Methods and Apparatus for Wireless Phone Optimizations of Battery Life, Web Page Reloads, User Input, User Time, Bandwidth Use and/or Application State Retention

(76) Inventor: Jan Rippingale, Cobb, CA (US)

(21) Appl. No.: 13/055,049

(22) PCT Filed: Jan. 8, 2009
(86) PCT No.: PCT/US09/00156

§ 371 Date: Jan. 20, 2011

Related U.S. Application Data
(60) Provisional application No. 61/026,518, filed on Feb. 6, 2008.

(51) Int. Cl. H04M 1/00; H04M 3/00

(52) U.S. Cl. 455/418; 455/566

(57) ABSTRACT

This disclosure teaches using a wireless phone by a user to save and/or send a state in response to the user turning away. The user may interact with a web view to send the state as a non-empty transaction list in response to the user triggering a web navigation activator, with an application by storing the application state after the user looks away, and/or through an operating environment with at least two applications by storing the application state of the previous active application in response to the active application changing. The wireless phone may embody at least one of these interactions and may include a processor. Also disclosed, a program system, installation package and/or a download server in accord with at least one of these embodiments. A wearable display configured to wirelessly communicate with the phone and display web view presentations and/or application displays is also disclosed.

### CROSS REFERENCE TO RELATED PATENT DOCUMENTS

This patent application claims priority to provisional patent application No. 61/026,518 filed Feb. 6, 2008, and PCT Application PCT/2009/00156, filed Jan. 8, 2009, which are incorporated herein by reference in their entirety.

### TECHNICAL FIELD

This invention relates to wireless phones and the effect of user interactions on the wireless phone leading to the saving and/or sending of a state or state change.

### BACKGROUND OF THE INVENTION

Today, there are many wireless phones and very large numbers of users of these phones. One may use their wireless phone in a variety of ways: operate standard computer applications such as word processors and spreadsheets, make purchases, play games, interact with email and/or text messaging, browse web content, operate online search services possibly to get a map, and/or make a stock trade. While these devices constitute a breakthrough over the technology of the last century, they are not without their inefficiencies.

There are three inefficiencies to consider: Wireless phones tend to be harder to use for text related purposes in that they do not tend to have full sized keyboards, which may make user input more difficult and time consuming. Wireless phones often employ a multi-tasking operating environment that allows the user to pause writing a text to answer a phone call. If the power fails or the wireless phone is turned off, the text message or document has probably been lost. And thirdly, wireless phones involve some inherent systems overhead, their battery life, the bandwidth of the base station communicating with the wireless phone and the number of discrete human interface events such as key strokes needed to achieve the immediate goals of the phone's user.

These inefficiencies form the central technical problems that various embodiments of this invention address, which is against the backdrop of the widely observed human tendency to do repetitive tasks in the simplest, fastest way. Humans demand simplifications that make their lives easier. This market pressure has fueled repeated innovations in this technical field.

### SUMMARY OF THE INVENTION

This invention includes three primary apparatus embodiments that share similar methods of operating a wireless phone. The phone may save and/or send a state in response to the user “looking away”, by the user interacting with a web view triggering web navigation, by interacting with an application's display, and/or by interacting with the operating environment.

Each of these embodiments address one or more of the inefficiencies found in the prior art, providing their human users with a more convenient and reliable interface to their wireless phone. The first embodiment interacting with the web view optimizes web page reloads, battery life through minimizing transmissions and the use of bandwidth. The second embodiment interacting with the application display to save the application state when the user is “looking away” saves the user's input and time as well as retaining the application state in case of power failures or sudden phone termination. The third embodiment interacting the operating environment saves the application state in response to determining there is a change in the active application, this also saves the user input, time and retains the application state through power failures or sudden phone termination.

Interacting with the web view may include creating the state as a transaction list that generates traffic to a base station in response to the user activating web navigation. Interacting with an application's display may include determining when the user looks away from the display and saving the application state in response to that. The operating environment may support multiple applications each including an application display and an application state. Interacting with the operating environment may include determining a change in the active application and saving the application state of the previously active application. Saving the application state will refer to operating a non-volatile memory for later retrieval by the application to return it to that application state.

These embodiments of the wireless phone may include means for interacting with the web view as shown in FIG. 2, means for interacting with the application's display as in FIG. 3, and means for interacting with the operating environment as in FIG. 4.

These embodiments may be implemented using at least one processor that may include instances of a computer instructed by a program system residing in a computer readable memory, an inference engine accessing a rule set residing in a memory, and a finite state machine. The program system may be created and/or modified in accord with this invention by an installation package. The rule set may be created and/or modified by a rule set upgrade. And the finite state machine may be created and/or modified by a finite state machine configuration.

Embodiments of the invention include a download server providing at least one of the following to the processor: the program system, the installation package, the rule set, the rule set upgrade and/or the finite state machine configuration. Any of these may be provided by a computer readable memory configured to access the computer, inference engine and/or finite state machine.

### BRIEF DESCRIPTION OF FIGURES

FIG. 1 shows a block diagram of a wireless phone with a phone number with the wireless phone supporting at least bidirectional audio communication for a user by utilizing a radio transceiver based upon requesting a phone session through a base station, with a requested phone number and a requesting phone number that is a version of the phone number of the wireless phone. This block diagram describes a common condition of wireless phones as used herein.

FIG. 2 shows an example of the first wireless phone embodiment that interacts with a web view included in a web browser. The wireless phone includes and uses the web view to generate a transaction list. The non-empty transaction list is sent to the base station in response to the user providing user input that triggers web navigation, which creates traffic at the base station that includes the received transaction list and a web page request.

FIG. 3 shows an example of the second wireless phone embodiment that relates to an application that includes the means for determining when the user looks away from the application's display and the means for saving the application state to non-volatile memory in response to determining that the user has looked away from the application's display to create a stored application state in the non-volatile memory.

FIG. 4 shows an example of the third embodiment including an operating environment for a wireless phone supporting at least two applications, each including an application display and an application state. The operating environment includes a means for determining a change of the active application and a means for storing an application state in a non-volatile memory.

FIGS. 5 to 13 show some examples of a processor in the wireless phone with various combinations of web browser engines, applications and the operating environment. An application may instruct a web browser and/or a computer and/or an inference engine and/or may be implemented as one or more finite state machines included in the wireless phone. The processor may communicate with a download server to receive installation packages, program systems, rule sets, rule set upgrades and/or finite state machine configurations in various embodiments of the invention.

FIG. 14 shows a block diagram of some details of various implementations of the means for determining the user looking away of FIG. 3 and/or means for determining the change in the active application of FIG. 4.

FIG. 15 shows some details of the installation package of FIG. 11.

FIG. 16 shows some details of the web view of FIG. 2.

And FIG. 17 shows the wireless phone including a wireless interface configured to wirelessly communicate with a wearable display providing visual input to the user and receiving motion feedback from the user to indicate when the user has looked away from a presentation of the web view and/or an application display.

### DETAILED DESCRIPTION OF FIGURES

This invention relates to wireless phones and the effect of user interactions on the wireless phone leading to the saving and/or sending of a state or state change.

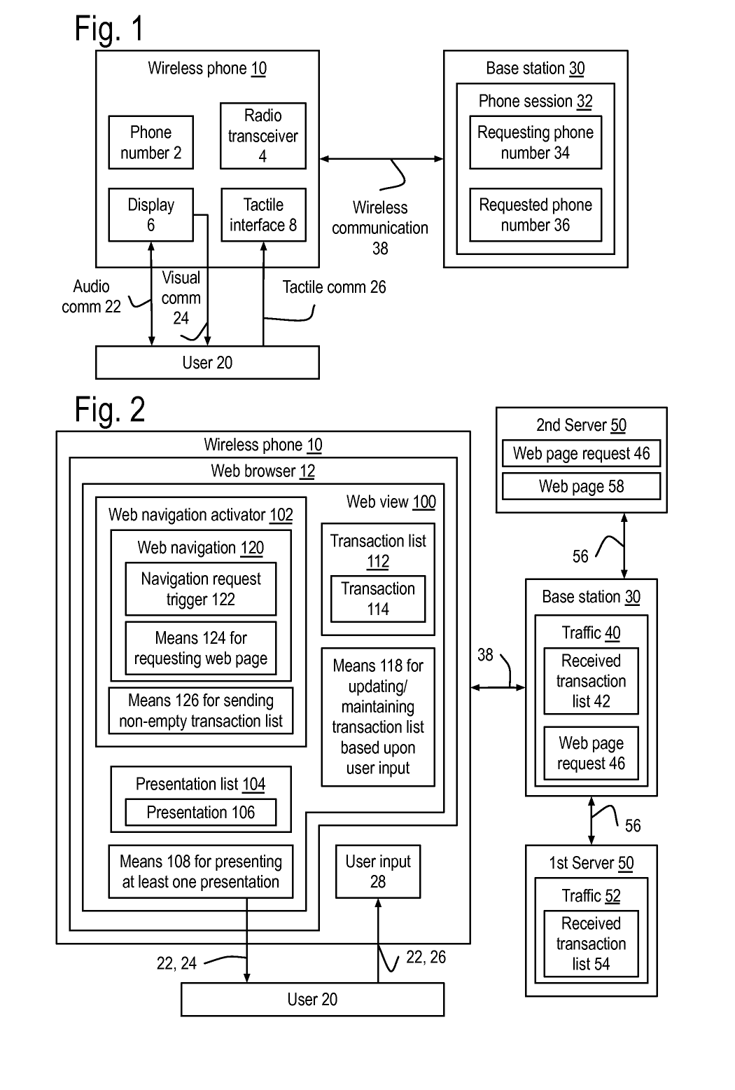

FIG. 1 shows a block diagram of a wireless phone 10 with a phone number 2, the wireless phone supports at least bidirectional audio communication for a user 20 utilizing a radio transceiver 4 based upon requesting a phone session 32 through a base station 30, with a requested phone number 36 and a requesting phone number 34 that is a version of the phone number of the wireless phone. The wireless phone is preferably in wireless communication 38 with the base station. This block diagram describes a common condition to wireless phones as used herein.

The user 20 may interact with the wireless phone 10 through a display 6 and/or a tactile interface 8. By way of example, the display may present and/or receive audio communication 22 with the user. The display may also provide visual communication 24 to the user. The tactile interface may receive tactile communication 26 from the user, possibly in response to the display's presentation of visual and/or audio communications.

Typically, the wireless phone 10 may operate the display 6 as at least one of a multiple-instance display system that selects one instance of presentation to the user 20 and/or as a window management system operating at least one and often multiple windows within at least one instance of a window display. Examples of contemporary wireless phones may include the capabilities of a personal digital assistant and/or a compressed media player and/or a handheld computer.

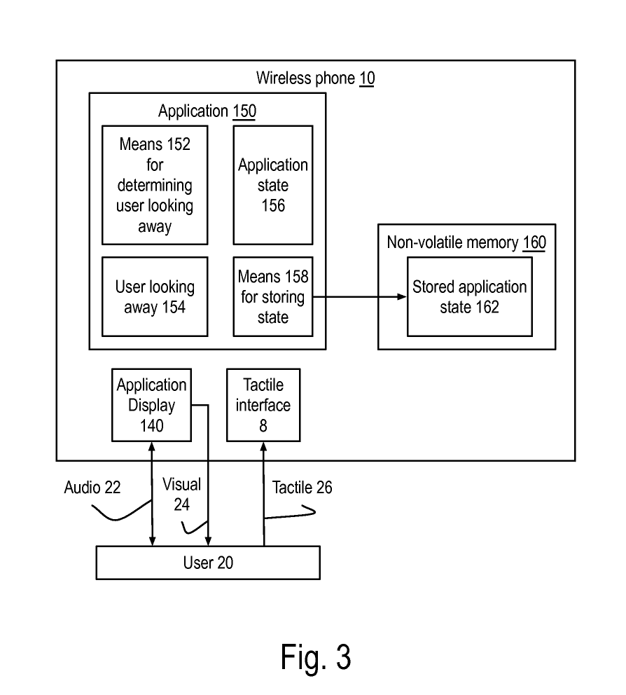

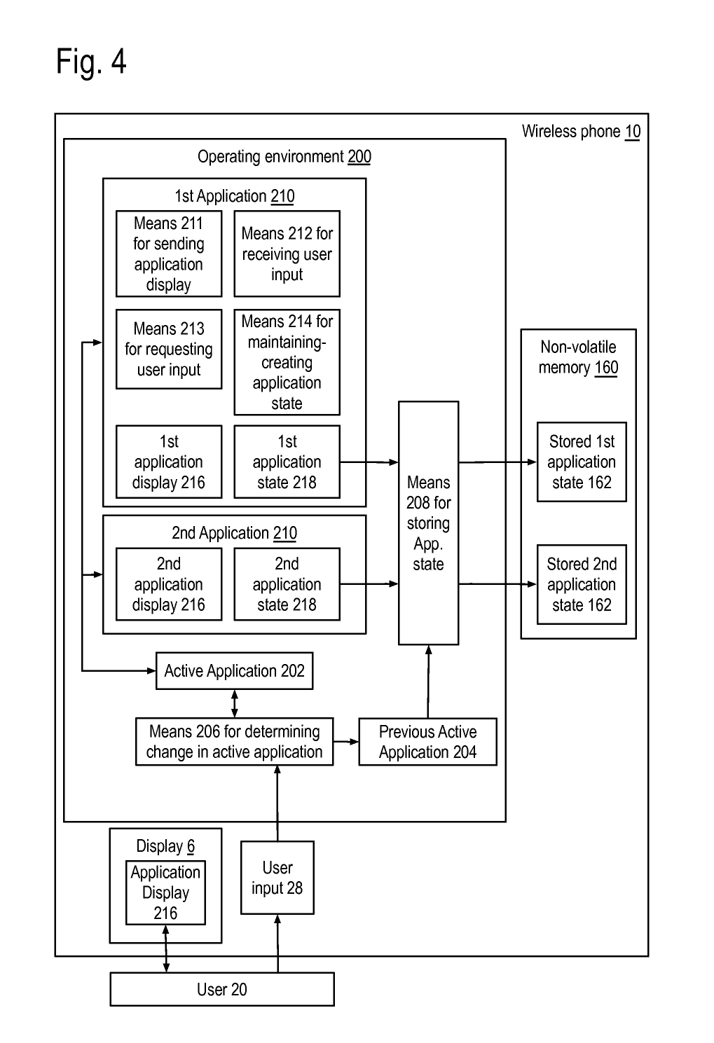

This invention includes three primary apparatus embodiments that share similar methods of operating a wireless phone. A user 20 may use the wireless phone 10 to save and/or send a state in response to the user looking away, by interacting with a web view 100 as shown in FIG. 2, by interacting with an application's 150 application display 140 as shown in FIG. 3, and/or by interacting with the operating environment 200 of the wireless phone as shown in FIG. 4. Saving and/or sending will be referred to herein as saving-sending. As used herein, looking away will include the user's attention no longer being focused on an application, which may include but is not limited to a phone call interruption, triggering a web navigation and/or the user turning their head away from the display.
Interacting with the web view 100 may include sending the state as a transaction list 112 that generates traffic 40 to a base station 30 in response to the user 20 activating a web navigation activator 120 as in FIG. 2.
Interacting with an application's 150 application display 140 may include determining 152 when the user looks away 154 from the application display and storing the state as an application state 156 in response to the user looking away. As used herein, storing the application state effectively saves the application state so that it can be retrieved, allowing the application to resume its operations with the application state as of the time it was stored as in FIG. 3.
The operating environment 200 of the wireless phone may support multiple applications 210 each including an application display 216 and an application state 218. Interacting with the operating environment may include determining 206 a change in the active application 202 and storing the application state of the previously active application 204 in response to the change as in FIG. 4.

FIG. 2 shows an example of the first set of wireless phone 10 embodiments interacting with the web view 100 to trigger sending 126 a non-empty transaction list 112 with the triggering of a web navigation activator 102 within a web browser 12. Here, the wireless phone includes and uses the web view to generate a transaction list 112 that may include at least one transaction 114. The non-empty transaction list is sent to the base station 30 in response to the user 20 providing user input 28 triggering the web navigation activator 102. The navigation activator combines web navigation and sending the transaction list just by triggering the web navigation. Sending the transaction list to the base station creates traffic 40 at the base station including the received transaction list 42 and a web page request 46.

The web view 100 includes a presentation list 104 containing at least one presentation 106, the transaction list 112 that may be empty or contain at least one transaction 114, at least one web navigation activator 102, means 108 for presenting at least one presentation from the presentation list and means 118 for updating/maintaining the transaction list based upon user input 28.

The web navigation activator 102 may preferably include a web navigation 120 and means 126 for sending the non-empty transaction list 112. The web navigation may include a navigation request trigger 122 and a means 124 for requesting a web page 58. The means 126 for sending the non-empty transaction list preferably acts in response to the user 20 stimulating the navigation request trigger. The means 124 for requesting the web page may preferably include means for sending the request 46 for the web page via the radio transceiver 4 of FIG. 1 to the base station 30.

The base station 30 may preferably communicate 56 with a first server 50 to create server traffic 52 that includes the received transaction list 54 and may also communicate with a second server 50 to deliver the web page request 46. The second server preferably responds by sending the web page 58 via the base station to the wireless phone 10. Note that some web page requests may be made to the same server that receives the transaction list.

For example, the web navigation activator 102 may respond to the user input 28 stimulating buttons, such as “Home”, “Back”, “Bookmarks”, “Refresh”, hyperlinks, and/or “New Page” by sending the web page request 46 and the non-empty transaction list 112 to the base station 30 to create the received transaction list 42 and the web page request 46 as the traffic 40.

As shown in FIG. 2, the user 20 may preferably interact with the web view 100 as follows:
The display 6 and possibly the audio 22 subsystem of the wireless phone 10 may be directed by the web view and possibly one or more user input 28 to present at least one presentation 106.
The user may stimulate the wireless phone 10 to create at least one user input 28 to create and/or modify at least one transaction 114 included in the transaction list 112.
The web view 100 may preferably use the radio transceiver 4 to send a non-empty transaction list 112 to the base station 30 in response to the user stimulating a web navigation activator 102.

This approach does not require an action other than activating the navigation request trigger 122 to send the transaction list 112, nor does it require the often frequent reloading of the web view 100, both of which improve the user 20 convenience and minimize key strokes and/or tablet strikes and/or mouse clicks, all of which are tangible improvements in the performance of the wireless phone 10.

This approach also limits the bandwidth requirements of the traffic 40 on the base station 30, another tangible, measurable product of the process of operating and using the wireless phone 10. Further products of this method may include the traffic bandwidth delivered to a server 50 interacting 56 with the base station, which is also measurable and tangible.

FIG. 3 shows an example of the second embodiments of the invention that relate to an application 150 included in the wireless phone 10 that includes the means 152 for determining when the user 20 looks away from the application's display 140 and the means 158 for storing the application state 156 to non-volatile memory 160 in response to determining that the user has looked away 154 from the application's display to create the stored application state 162 in the non-volatile memory 160. As used herein, a non-volatile memory tends to retain its state without consuming power.

As used herein the user 20 looking away may also include the application 150 determining that it is no longer the active display and/or the application determining that it is no longer an active window and/or the application determines that its active application display or window has changed. This may occur when one is using their wireless phone to make a purchase from a web site, playing a game, writing an email, reading an email, responding to an email, text messaging, creating an email distribution list, creating an address book or entry, browsing content on a web page, creating a bookmark of a webpage, getting a map or other online search service, using a calculator function, making a stock trade, uploading a photograph, creating a slide show, and/or creating a playlist. Examples of a change in the active application display, include but are not limited to when the user switches the top or in-focus window from one email to another, from one spreadsheet to another or one document to another.

The saved application state 160 safeguards the user's 20 efforts from power failure on the wireless phone 10, which might otherwise be lost in a power failure, system shutdown and/or other termination of normal operations of the wireless phone.

FIG. 4 shows an example of the third embodiment including an operating environment 200 for a wireless phone 10 supporting at least two applications 210, each including at least one application display 216 and an application state 218. The operating environment includes a means 206 for determining a change of the active application 202 and a means 208 for storing an application state in a non-volatile memory 160. For example, the first application state may be stored in the non-volatile memory as the stored first application state 162, and so on.

The means 206 for determining the change of the active application 202 may be triggered by the user 20 and/or other functions and/or other means in the operating environment 200.

When the active application 202 changes, an indication of the previous active application 204 is sent to the means 208 for storing the application state 218 of the previously active application to the non-volatile memory 160, creating the saved application state 162. Some example of these indications include but are not limited to a message sent to the means 208 to store the application state referenced by a memory pointer and/or by an object handle to the application 210. The object may include a method that presents a stream of data to the means 208 for storage.

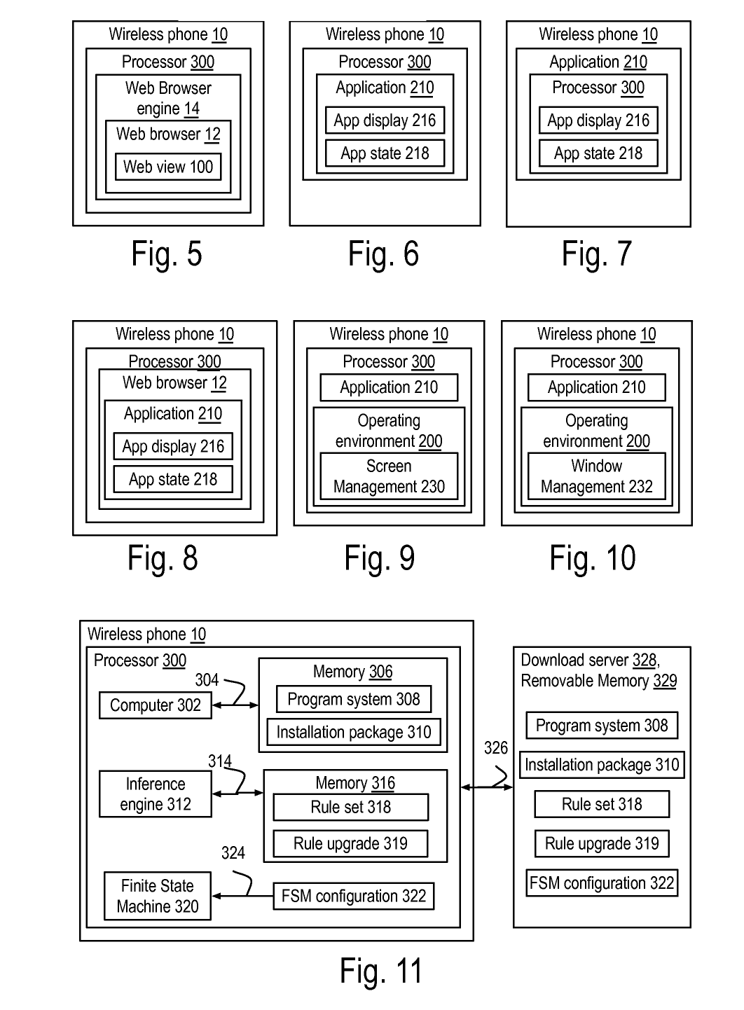

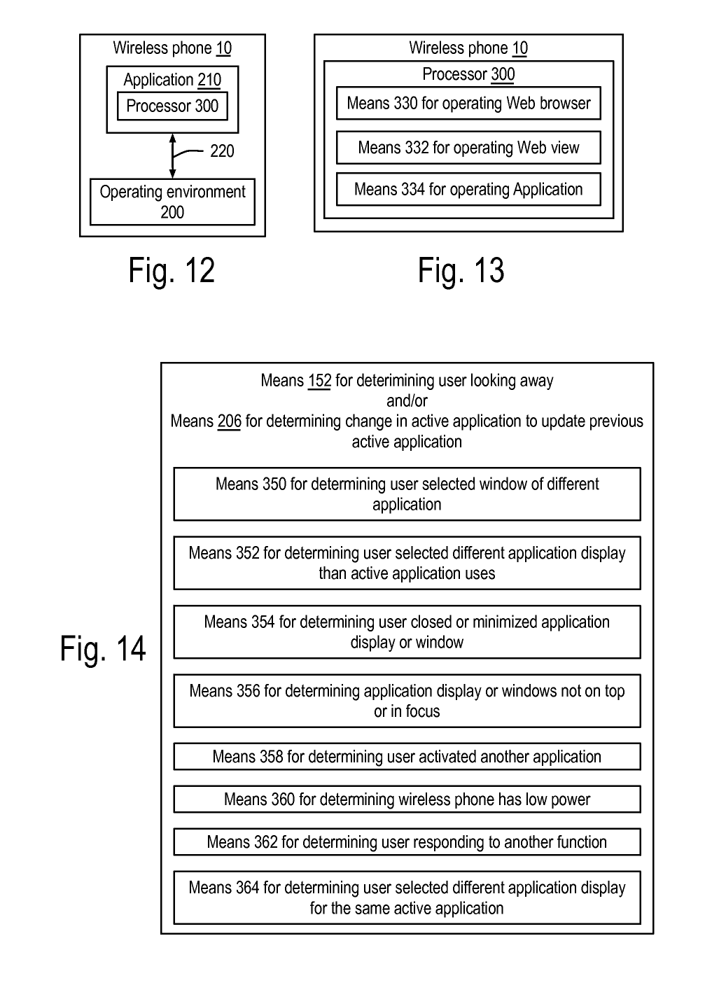

FIGS. 5 to 13 show some examples of a processor 300 in the wireless phone 10 with various combinations of web browser engines 14, applications 210 and operating environments 200. An application may instruct a web browser 12 and/or a computer 302 and/or an inference engine 312 and/or may be implemented as one or more finite state machines 320 included in the wireless phone. The processor may communicate 326 with a download server 328 and/or removable memory 329 to receive installation packages 310, program systems 308, rule sets 318, rule set upgrades 319 and/or finite state machine configurations 322 in various embodiments of the invention.

FIG. 5 shows the wireless phone 10 including the processor 300 further including the web browser engine 14 executing the web browser 12 that in turn executes the web view 100. The web browser engine may execute a form of Java, for example.

FIG. 6 shows the wireless phone 10 also including the processor 300 that further includes the application 210 with its application display 216 and its application state 218.

FIG. 7 shows the wireless phone 10 including the application 210 that contains a processor 300 to at least partly operate its application display 216 and/or its application state 218.

FIG. 8 shows the wireless phone 10 including the web browser 12 that operates the application 210 with its application display 216 and its application state 218.

FIGS. 9 and 10 show the wireless phone 10 including the processor 300 containing the application 210 and the operating environment 200 that may include the screen management system 230 as shown in FIG. 9 and the window management system 232 in FIG. 10.

FIG. 11 shows the wireless phone 10 and its processor 300 may include at least one instance of a computer 302 accessibly coupled 304 to a computer readable memory 306 containing a program system 308 of at least one program step residing in the memory for instructing the computer in accord with at least one embodiment of this invention. The processor may include at least one instance of an inference engine 312 accessibly coupled 314 to a memory 316 containing a rule set 318. And the processor may include at least one finite state machine 320 supporting at least part of an operation of an embodiment of the invention.

As used herein, a computer 302 may include at least one data processor and at least one instruction processor, with each of the data processors instructed by at least one of the instruction processors, and at least one of the instruction processors receives program steps as instructions from the accessibly coupled computer readable memory.

FIG. 11 also shows embodiments of the invention that can install, modify and/or upgrade the processor 300 in accord with the invention.
The computer 302 may receive 326 an installation package 310 possibly from a download server 328 and/or from a removable memory 329. The installation package may create the program system 308 and/or modify the program system to implement an embodiment of the invention. The installation package may also be contained in the computer readable memory 306. The download server and/or removable memory may also deliver to the processor a version of the program system, possibly in a compressed and/or encrypted form, possibly in the form of source code or an intermediate code, such as Java byte codings.
The inference engine 312 may receive 326 a rule upgrade 319 from the download server 328 and/or the removable memory 329 that may create and/or modify the rule set 318 in accord with an embodiment of the invention. The download server may deliver the rule set to the processor 300 in a compressed and/or encrypted form, possibly in the form of source code or an intermediate code, such as the Prolog engine coding of the Warren engine.
The finite state machine 320 may be configured 324 by a finite state machine configuration 322 received 326 from the download server 328 and/or the removable memory 329. Examples of such finite state machines include Field Program Gate Arrays (FPGA). In certain embodiments, the finite state machine configuration may be provided by a computer readable memory 306 that is used by a computer 302 to configure the finite state machine, possibly when initializing the wireless phone 10.
As used herein, the removable memory 329 may include but is not limited to a solid state memory cartridge, such as frequently used in digital cameras, a USB memory device, a music and/or video media player, a firewire memory device, and/or an optical disk that may be encoded using standard lasers and/or a blue ray laser.

To summarize some of the configurations that may be preferred, the operating environment 200 may include, but is not limited to, a web browser engine 14, a screen management interface system 230 and/or a window management interface system 232. Any of these may be implemented as a combination of at least one instance of any of the following:
A program system 308 for instructing the computer 302 and including program steps residing in a computer readable memory 306 that may be accessibly coupled 304 to the computer,
A finite state machine 320,
A finite state machine configuration 322,
And/or a rule set 318 used by an inference engine 312, the rule set residing in a memory 318, preferably a non-volatile memory, accessibly coupled 314 to the inference engine.

The operating environment 200 of FIG. 4 is further shown in FIGS. 9, 10 and 12.
The application 210 may include an add-on or plug-in to the web browser 12 that may be executed by the web browser engine 14 as shown in FIG. 5.
Alternatively, an application program system 308 may interact with the screen management interface system 230 and/or with the window management interface system 232 as shown in FIGS. 9 and 10.
Also an application means may communicate 220 with the operating environment as shown in FIGS. 4, 9, 10 and/or 12.
The application means may include hardware (means) as follows: means 211 for sending the application display 216 to the operating environment for display 6 to the user 20, means 213 for requesting user input 28 from the operating environment, means 212 for receiving the user input from the operating environment and means 214 for maintaining/creating the application state 216 based upon the application display 218 and the user input 28.

Because of the complexity and variations in how the invention embodiments may be implemented, a decision has been made to focus on means plus function apparatus language.
The embodiments of the invention may therefore include means for performing something that may be considered a method.
The means may also include at least partial implementation as hardware.
The means may include a program operation, or program thread, executing upon a computer 302, and/or a state transition in a finite state machine 320 and/or traversal of a node in an inferential graph of the inference engine 312 and/or of its rule set 318.
The means may start its operation by entering a subroutine or a macro instruction sequence in the computer, and/or directing a state transition in the finite state machine, possibly while pushing a return state.
The means may terminate upon completion of those operations, which may result in a subroutine return in the computer, and/or popping of a previously stored state in the finite state machine, and/or returning to a previous level of inference in the inference engine.
However, upon termination, the means will not be considered to cease existing, in that a tangible structure will be retained at least for a while that may again be started, operated and then possibly terminated again.

FIG. 13 shows that various embodiments of the wireless phone 10 may include the processor 300 that may further include at least one of the following: Means 330 for operating the web browser 12. Means 332 for operating the web view 100. And means 334 for operating the application 210.

FIG. 14 shows a block diagram of some details of various implementations of the means 152 of FIG. 3 for determining when the user 20 looks away and/or means 206 of FIG. 4 for determining the change in the active application 202 to update the previous active application 204. Either one or both of these may include, but is not limited to, at least one of the following: Means 350 for determining that the user may select a window of a different application 210. Means 352 for determining that the user may select a different application display 216 than the active application uses. Means 354 for determining that the user may close or minimize the display or window used by the application. Means 356 for determining that the application display and/or the application windows are not on top or in focus. Means 358 for determining that the user has activated another application, possibly by selecting its icon or an entry in a list. Means 360 for the wireless phone 10 indicating a low power condition. Means 362 for determining that the user has responded to another function, such as receiving a stock quotation, an instant message and/or a telephone call and/or a calendar notice. And/or means 364 for determining that the user selected a different application window for the same active application, for instance brought one email into focus from looking at another, one document from looking at another, and/or one spreadsheet from looking at another.

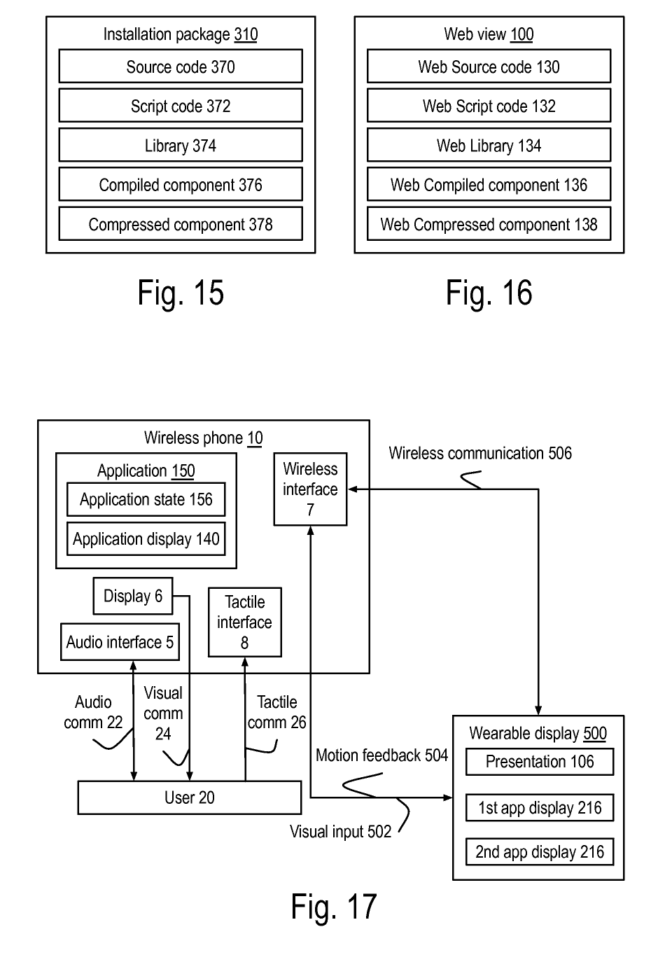

FIG. 15 shows some details of the installation package 310 of FIG. 11. The installation package may include, but is not limited to, at least one of the following: source code 370, script code 372, at least one library 374, at least one compiled component 376 and/or at least one compressed component 378. Examples of source code include, but are not limited to, text files that are syntactically and/or semantically consistent with programming languages such as C, C++, and assembler languages for various computers such as the Intel 8086 family, the PowerPC family and the ARM computer families. Examples of script code include make files. Examples of libraries include linkage libraries of compiled components. Compiled components may further include relocatable loader formatted components. Compressed components may include compressed files of any combination of the other components of the installation package.

The installation package 310 may operate by exploiting a weakness or back door in the operating environment 200 to inject one or more root kits into the operating environment that may alter one or more basic utilities of the operating environment, for instance by altering how the operating environment determines the active application 202 has changed and responding to that change by saving 208 the application state 218 of the previous active application 204 in the non-volatile memory 160. Operating the installation on a processor 300 may trigger the reflashing of firmware in the non-volatile memory to at least partly implement the invention by altering the operating environment. Note that partial implementation of the invention may occur through the use of preexisting components.

FIG. 16 shows some details of the web view 100 of FIG. 2. The web view may include, but is not limited to, at least one of the following: web source code 130, web script code 132, at least one web library 134, at least one web compiled component 136 and/or at least one web compressed component 138. Web source code and/or web script code may include, but are not limited to, at least one version of java, javascript, html, dbscript and php. The web library may include but is not limited images, audio files, video streams, all of which may also be web compressed and/or compiled components.

FIG. 17 shows the wireless phone 10 including a wireless interface 7 configured to wirelessly communicate 506 with a wearable display 500 providing visual input 502 to the user 20 and receiving motion feedback 504 from the user to indicate when the user has looked or turned away from a presentation 106 of the web view 100 and/or an application display 216. The wireless communication may preferably be a form of radio communication that may further be a version of the Bluetooth standard. The wearable device may look like a pair of glasses in certain embodiments. The wireless phone may further include an audio interface 5 to the audio communication 22 with the user. Note that in some embodiments, the tactile interface 8 may be a layer on the display 6, forming a touch screen.

The preceding embodiments provide examples of the invention, and are not meant to constrain the scope of the following claims.

1. A method, comprising the step of:
using a wireless phone by a user to save-send a state in response to said user looking away, further comprising at least one of the steps of:
said user interacting with a web view to send said state as a non-empty transaction list after said user triggers a web navigation activator;
said user interacting with an application on said wireless phone by determining when said user looks away and storing said state as an application state in a non-volatile memory in response to said user looking away; and
said user interacting through an operating environment with at least two of said applications by determining a change in an active application to update a previous active application and storing said application state of said previous active application in response to said change in said active application.

2. The method of claim 1,
wherein the step of said user interacting with said wireless phone through said web view, comprising the steps of:
presenting at least one presentation included in said web view to said user to create a user input and update-maintain a transaction list;
said user input activating said web navigation activator to send a web page request and said non-empty transaction list to a base station communicating with said wireless phone;
wherein the step of said user interacting with said application on said wireless phone, further comprising the steps of:
determining when said user looks away; and
storing said application state in said non-volatile memory in response to said user looking away;
wherein the step of said user interacting through said operating environment with said applications, further comprising the steps of:
determining a change in an active application to update a previous active application; and
storing said application state of said previous active application in response to said change in said active application.

3. A wireless phone configured to implement the method of claim 1, comprising at least one member of the group consisting of:
means for interacting with said web view, further comprising
means for presenting at least one presentation included in said web view;
means for updating-maintaining a transaction list based upon at least one user input resulting from said user interacting with said presentation; and
at least one web navigation activator further comprising a web navigation and
a means for sending said non-empty transaction list in response to said user input triggering said web navigation;
means for interacting with said application, further comprising
means for determining when said user looks away; and
means for storing said application state in said non-volatile memory in response to said user looking away;
means for interacting with said operating environment, further comprising
means for determining said change in said active application to update said previous active application; and
means for storing said application state of said previous active application in response to said change in said active application.

4. The wireless phone of claim 3, further comprising at least one processor at least partly implementing at least one of said means.

5. The wireless phone of claim 4, wherein said processor comprises at least one instance of at least one member of the group consisting of:
a computer accessibly coupled to a computer readable memory containing a program system including at least one program step instructing said computer to implement at least part of at least one of said means;
an inference engine directed by a rule set residing in an accessibly coupled memory; and
a finite state machine.

6. The wireless phone of claim 6, wherein said processor receives at least one member of the group consisting of:
an installation package to at least partly implement said program system;
a rule set upgrade to at least partly implement said rule set;
a finite state machine configuration to at least partly implement said finite state machine;
said program system and
said rule set.

7. The computer readable memory for the wireless phone of claim 6, containing at least one member of the group consisting of said program system, said installation package, said rule set, said rule set upgrade, and said finite state machine configuration.

8. A download server configured to communicate with said wireless phone of claim 6 to provide at least one member of the group consisting of:
said installation package to at least partly implement said program system;
said rule set upgrade to at least partly implement said rule set;
said finite state machine configuration to at least partly implement said finite state machine;
said program system and
said rule set.

9. A removable memory configured to communicate with said wireless phone of claim 6, containing at least one member of the group consisting of:
said installation package to at least partly implement said program system;
said rule set upgrade to at least partly implement said rule set;
said finite state machine configuration to at least partly implement said finite state machine;
said program system and
said rule set.

10. The wireless phone of claim 3, wherein said operating environment includes at least one member of the group consisting of a window management system and a display management system.

11. The wireless phone of claim 3, further comprising a wireless interface configured to communicate with a wearable display providing said user with visual input of at least one member of the group consisting of a presentation included in said web view and at least one of said application displays.

12. The wireless phone of claim 11, wherein said wireless interface is further configured to communicate with said wearable display to receive motion feedback from said user to indicate said user looking away.

13. The wearable device configured to wireless communicate with said wireless phone of claim 11 and further configured to display at least one member of said group consisting of said presentation and said application display.
